(19) United States
(12) Patent Application Publication
(10) Pub. No.: US 2026/0171285 A1
(43) Pub. Date: Jun. 18, 2026

(54) PUSH-CABLE WITH OFFSET JACKET EXTRUSION

(71) Applicant: SeeScan, Inc., San Diego, CA (US)

(72) Inventors: Mark S. Olsson, La Jolla, CA (US); Alexander L. Warren, Escondido, CA (US)

(21) Appl. No.: 19/382,881

(22) Filed: Nov. 7, 2025

Related U.S. Application Data
(60) Provisional application No. 63/719,026, filed on Nov. 11, 2024.

(51) Int. Cl. H01B 7/00; H01B 3/44; H01B 7/02; H01B 11/00

(52) U.S. Cl. CPC H01B 7/0081; H01B 3/441; H01B 3/445; H01B 7/0225; H01B 11/002

(57) ABSTRACT

Video push-cables, and methods for manufacturing video push-cables are disclosed. One embodiment may include an insulated push-cable with a fiberglass rod structural center member. A parallel bonded conductor including two separately insulated conductors is positioned along, and touches the center structural member along the length of the push-cable. The two conductors are insulated so that they are substantially equidistance from each other along the length of the center structural member. Since the parallel bonded conductor controls the distance between the two conductors, they are unlikely to short out if accidentally cut or otherwise damaged. In another embodiment, a push-cable fiberglass rod structural center member is surrounded by multiple concentric layers including a braided conductive layer, a layer of fiberglass rods and dielectric rods, a second braided conductive layer, and an insulated jacket. Other layers may be included.

### CROSS-REFERENCE TO RELATED APPLICATIONS

This application claims priority under 35 U.S.C. § 119(e) to U.S. Provisional Patent Application Ser. No. 63/719,026 entitled PUSH-CABLE WITH OFFSET EXTRUSION JACKET, filed Nov. 11, 2024, the content of which is incorporated by reference herein in its entirety for all purposes.

### FIELD

This disclosure relates generally to push-cables having a composite cable structure for providing electrical power and data or other signaling between a camera head and a cable reel control unit (CRCU) or other display device. More specifically, but not exclusively, this disclosure relates to push-cables with an offset jacket extrusion, and with mixed media over fiberglass rod push-cables with improved manufacturability.

### BACKGROUND

Devices and methods for inspecting the interior of buried or hidden pipes, conduits, or other cavities using imaging are well known in the art. For example, FIG. 1 shows an existing pipe inspection system that may include a camera head coupled to a video push-cable, with the camera head pushed into the pipe to facilitate displaying, recording and/or mapping of the pipe interior by capturing images or video for display or recording.

FIG. 2 illustrates a detailed view of one embodiment of a multi-dielectric coaxial push-cable, as known in the prior art. In this configuration, a push-cable typically includes a resilient, elastic element such as a fiberglass rod which is positioned in the center of the cable. The fiberglass rod is often covered by some sort of insulating outer layer, or jacket which provides electrical and environmental protection. One or more conductive elements are embedded in the fiberglass rod. Also, one or more layers of shielding are often included in the push-cable. If the push-cable is accidentally cut or nicked, one or more layers can easily be damaged. For instance, the shielding may be damaged, or one or more conductors may come in contact with another conductor, resulting in a short. Furthermore, the extrusion process for making this type of cable is very detailed, and time consuming.

What is needed in the art is a more robust push-cable that can better tolerate nicks and cuts that may occur when the push-cable is being moved throughout a buried or hidden pipe or conduit during inspection, or during cleaning or clearing of the pipe or conduit. Furthermore, it would be desirable to provide a method to manufacture such an improved push-cable that is quicker and more efficient than currently known extrusion and other push-cable production methods that are in use.

Accordingly, the present invention is directed towards addressing the above-described problems and other problems associated with push-cables for utility pipe inspection, and manufacturing methods there of, as well as a cable design that is easier to terminate, and connect to.

### SUMMARY

In accordance with various aspects of this disclosure, one video push-cable embodiment may include a flexible resilient central structural element. The central structural element may include a circular rod, although other shapes may be used. The rod may be constructed of fiberglass, Kevlar®, Spectra®, or any other material suitable for allowing the push-cable to be deployed and/or retracted through long lengths of underground or hidden pipes or conduits which may have many sharp twists and turns.

The video push-cable embodiment may further include two parallel bonded flexible conductors positioned adjacent to, and in contact with the central structural element along the full length of the central structural element. Each of the two parallel bonded flexible conductors may include a plurality of flexible copper conductive rods, spiraled copper tubular rods, or strands of copper wires surrounding a nylon core. Insulation is provided both around and between the two conductors. As an example, the insulation may be polypropylene, oiled polypropylene, or another insulation material. The insulation may be substantially hour glass (dog bone) shaped. That is, although the insulation is substantially symmetrical along a centerline that goes from the top to the bottom of the insulation, and cuts through the center of both of the two conductors, it is curved inward on both sides of the centerline, such that the curvature of the insulation forms two concave sides, and one of the two concave sides follows the convex curvature, and makes contact with the central structural element. It would be understood by one or ordinary skill in the art that other shapes may be considered. The insulation material, as well as the spacing (distance) between the two conductors, may be selected to provide a predefined electrical impedance value.

A jacket may be provided for enclosing the central element, and the two conductors. The jacket may be made of UHMW (ultra high molecular weight polyethylene), polypropylene, Teflon ®, or any other suitable material that provides electrical isolation, as well as environmental protection to the push-cable. The jacket may be circular or slightly oval.

In one video push-cable embodiment, the central structural element and the two conductors are offset from the center of the jacket. An offset value may be selected to provide predefined specific electrical, and/or strength characteristics to the push-cable such as a specific elastic modulus value. For instance, by offsetting the central structural element and the two conductors such that the approximate middle of the two conductors is substantially centered in the center of the jacket, the two conductors be further away from the jacket, thereby providing more insulation to the two conductors. This can reduce the likelihood of damage to the conductors if the push-cable is cut or nicked, and will improve electrical isolation from the two conductors, and any other pipes, conduits, or other conductors that the push-cable may come into contact with, or may be close by. Also, by positioning the two conductors as close to the fiberglass or other central structural element as possible, you maximize dielectric between the conductors, and between any other conductor, e.g. cast iron pipe, other conductive wiring in a pipe or conduit, in a cable drum-reel (i.e. other sections of the video push-cable that are wound in a cable drum-reel), etc.

The two parallel bonded flexible conductors may easily be pulled apart and separated from the insulation allowing the conductors to be easily accessed for termination/connection, as necessary. Examples of termination include but are not limited to soldering, crimping, and stripping insulation off of the conductors to allow for termination using various stripping tools. When manufacturing the video push-cable, the two insulated conductors are positioned next to the central structural element, and then run through an offset extruder. Different size cables can be made with different size central structural elements using the same size of two insulated conductors, thereby making the necessary terminations and connectors uniform for may different sized cables. The distance between the two conductors is controlled along the full length of the video push-cable by the selected insulation distance between them.

In one embodiment, the two conductors can be made semi-stretchy, e.g. conductive wires wrapped around a soft core such as a fiber or string core. You extrude the two wires with polypropylene or UHMW (ultra high molecular weight polyethylene) next to a fiberglass rod. This gets rid of a lot of the mechanical and manufacturing issues related to using hard, straight wires. Also, the polypropylene, UHMW, or other suitable material holds the desired spacing between components during the extrusion process. Placing the two conductors on a single side of the central structural element provides better impedance control because you set the distance between the conductors by the amount of insulation selected, and allows the cable to be made smaller and lighter, as opposed to putting the conductors on opposite sides of a central structural element.

The two conductors may be bonded to the central structural element, but they do not have to be. The central structural element may be coated with silicone or other similar oil to prevent the two conductors from bonding with the central structural element during the extrusion process. By leaving the central structural element unbonded from the pair of conductors, the central element and the two parallel bonded flexible conductors are free to move/slide relative to each other.

In another embodiment, a video push-cable may include a flexible resilient central structural element, an multiple concentric layers surrounding the central structural element. The central structural element may comprise a circular fiberglass rod. Other shapes and materials may be used. The concentric layers may include an inner conductive layer, and a plurality of elastic rods and a plurality of dielectric rods that are alternated around the central core, and an outer conductive layer. One or more of the conductive layers may comprise braided copper or a braided copper alloy. An outer cover or jacket enclosing the multiple concentric layers and the flexible resilient central structural element may be provided. The jacket may be made of polypropylene, Teflon®, or any other suitable material or combinations of materials that provide electrical isolation, as well as environmental protection to the push-cable. A tape layer may be provided between the inner conductive layer and the plurality of elastic rods and dielectric rods. Any open spacing between the plurality of elastic rods and the plurality of dielectric rods may be filled with air or back-filled with a water blocking compound.

The jacket may be substantially round shaped, slightly oval shaped, or shaped to provide two flat or substantially flat faces. A slightly oval shape allows the jacket to bend symmetrically when a force is applied by controlling the distribution of elastic modulus materials. This means that it would not have a preferential bending direction. Less constant bending in the same direction will reduce wear and tear, as well as potential failure of the video push-cable.

In some embodiments, one or more optional cable fillers (filler elements) may be used. For instance, if the cable jacket configuration includes a jacket with two flat or substantially flat opposing sides, one or more filler elements may be included to provide additional cable strength, as well as help the cable maintain its shape. There are many different filler materials available, each with different technical specifications. It would be understood by one of ordinary skill in the art that a specific material may be chosen depending on the specific desired characteristics of the filler element(s), as well as the specific end-use application of the push-cable.

In another embodiment, a video push-cable may include a single fiber glass rod or a bundle of fiberglass rods positioned adjacent to an electrical conductor cable. For instance, the bundle of fiberglass rods may include a 7 strand bundle of rods. A single fiber glass rod, or the bundle of fiberglass rods may be surrounded by insulation, i.e. jacketed. The electrical conductor cable may have an inner insulation layer or jacket, and an outer insulation layer or jacket. The whole push-cable assembly including the fiberglass rod(s) and electrical conductor(s) would be insulated with an outer jacket. The electrical cable may be positioned so that part of the cable is adjacent to the outside edge of the push-cable jacket along the length of the push-cable. That is, the outer jacket of the electrical cable, would form part of the outside jacket surround the whole push-cable assembly. A single fiberglass rod, or a bundle of fiberglass rods may optionally be surrounded by a layer of tape to allow the rod(s) to slide internally inside the jacket. The conductor cable may include one conductor, or a bundle of conductors. For example, the conductors may be a single copper rod, or multiple copper rods.

In some embodiments, the electrical conductors may include stranded copper wire. The stranded copper wire strands may be layed/situated parallel, slightly twisted, or significantly twisted. As an example, the electrical conductors may include twisted triad, i.e. a cable made up of three twisted conductors. The electrical conductors may be jacketed. The push-cable, including the fiberglass rod(s) and the electrical conductor(s) are insulated with an outside jacket. The outer jacket may be white, or a different color. The outer jacket may be polymer, e.g. UHMW (Ultra High Molecular Weight Polyethylene). The outer jacket may be substantially round shaped, or slightly oval shaped. The electrical conductors may include 2 or 3 conductors which may include braided or taped shield. Optionally, the electrical conductors may be high twist, high flex, high strength twisted conductors.

In one embodiment, the electrical push-cable may include a twisted triad comprising two insulated conductors, e.g. FEP (fluorinated ethylene propylene), PTFE (polytetrafluoroethylene), or other Teflon insulation, and a single larger bare conductor. Ideally, the conductor construction would provide a small amount of stretch. During construction the inner jackets, at least one surrounding the fiberglass rod(s), and at least one surrounding the electrical conductors, would not bond to the outer insulation or jacket during extrusion. The inner jackets could include Hypalon or TPR, or rubber like PP, PE, PVC, PU, etc. Ideally, slightly formable into a coil cord shape, if needed. Both the outer jacket of the push-cable, and the outer jacket of the electrical conductor may both be UHMW, or another material, and the jackets may be the same or different colors. If they are different colors, a stripe may be created on the outside of the push-cable jacket where the two different colored jackets meet. The outer jacket of the electrical conductor may also itself be striped.

Details of example devices, systems, and methods that may be combined with the embodiments disclosed herein, as well as additional components, methods, and configurations that may be used in conjunction with the embodiments described herein, are disclosed in co-assigned patents and patent applications including: U.S. Pat. No. 5,939,679, issued Aug. 17, 1999, entitled VIDEO PUSH CABLE; U.S. Pat. No. 6,545,704, issued Apr. 8, 1999, entitled VIDEO PIPE INSPECTION DISTANCE MEASURING SYSTEM; U.S. Pat. No. 6,831,679, issued Dec. 14, 2004, entitled VIDEO CAMERA HEAD WITH THERMAL FEEDBACK LIGHTING CONTROL; U.S. Pat. No. 6,862,945, issued Mar. 8, 2005, entitled CAMERA GUIDE FOR VIDEO PIPE INSPECTION SYSTEM; U.S. Pat. No. 6,958,767, issued Oct. 25, 2005, entitled VIDEO PIPE INSPECTION SYSTEM EMPLOYING NON-ROTATING CABLE STORAGE DRUM; U.S. patent application Ser. No. 12/704,808, filed Feb. 13, 2009, entitled PIPE INSPECTION SYSTEM WITH REPLACEABLE CABLE STORAGE DRUM; U.S. patent application Ser. No. 13/647,310, filed Feb. 13, 2009, entitled PIPE INSPECTION SYSTEM APPARATUS AND METHOD; U.S. patent application Ser. No. 13/346,668, filed Jan. 9, 2012, entitled PORTABLE CAMERA CONTROLLER PLATFORM FOR USE WITH PIPE INSPECTION SYSTEM; U.S. patent application Ser. No. 14/749,545, filed Jan. 30, 2012, entitled ADJUSTABLE VARIABLE RESOLUTION INSPECTION SYSTEMS AND METHODS; U.S. Pat. No. 8,289,385, issued Oct. 16, 2012, entitled PUSH-CABLE FOR PIPE INSPECTION SYSTEM; U.S. Pat. No. 8,395,661, issued Mar. 12, 2013, entitled PIPE INSPECTION SYSTEM WITH SELECTIVE IMAGE CAPTURE; U.S. patent application Ser. No. 13/826,112, filed Mar. 14 2013, entitled SYSTEMS AND METHODS INVOLVING A SMART CABLE STORAGE DRUM AND NETWORK NODE FOR TRANSMISSION OF DATA; U.S. patent application Ser. No. 14/033,349, filed Sep. 20, 2013, entitled PIPE INSPECTION SYSTEM WITH SNAP-ON PIPE GUIDES; U.S. Pat. No. 8,540,429, issued Sep. 24, 2013, entitled SNAP ON PIPE GUIDE; U.S. Pat. No. 8,587,648, issued Nov. 19, 2013, entitled SELF-LEVELING CAMERA HEAD; U.S. patent application Ser. No. 14/136,104, filed Dec. 20, 2013, entitled ROTATING CONTACT ASSEMBLIES FOR SELF-LEVELING CAMERA HEADS; U.S. patent application Ser. No. 14/203,485, filed Mar. 10, 2014, entitled PIPE INSPECTION CABLE COUNTER AND OVERLAY MANAGEMENT SYSTEM; U.S. patent application Ser. No. 14/207,527, filed Mar. 12 2014, entitled ROTATING CONTACT ASSEMBLIES FOR SELF-LEVELING CAMERA HEADS; U.S. patent application Ser. No. 14/216,358, filed Mar. 17 2014, entitled SMART CABLE STORAGE DRUM AND NETWORK NODE SYSTEM AND METHODS; U.S. patent application Ser. No. 14/557,163, filed Dec. 1, 2014, entitled ASYMMETRIC DRAG FORCE BEARINGS; U.S. Pat. No. 8,908,027, issued Dec. 9, 2014, entitled ASYMMETRIC DRAG FORCE BEARING FOR USE WITH PUSH-CABLE STORAGE DRUM; U.S. Pat. No. 8,970,211, issued Mar. 3, 2015, entitled PIPE INSPECTION CABLE COUNTER AND OVERLAY MANAGEMENT SYSTEM; U.S. patent application Ser. No. 14/642,596, filed Mar. 9, 2015, entitled PIPE CLEARING CABLES AND APPARATUS; U.S. Pat. No. 8,984,698, issued Mar. 24, 2015, entitled LIGHT WEIGHT SEWER CABLE; U.S. patent application Ser. No. 14/746,590, filed Jun. 22, 2015, entitled THERMAL EXTRACTION ARCHITECTURES FOR CAMERA AND LIGHTING DEVICES; U.S. Pat. No. 9,066,446, issued Jun. 23, 2015, entitled THERMAL EXTRACTION ARCHITECTURE FOR CAMERA HEADS, INSPECTION SYSTEMS, AND OTHER DEVICES AND SYSTEMS; U.S. Pat. No. 9,080,992, issued Jul. 14, 2015, entitled ADJUSTABLE VARIABLE RESOLUTION INSPECTION SYSTEMS AND METHODS; U.S. Pat. No. 9,134,255, issued Sep. 15, 2015, entitled PIPE INSPECTION SYSTEM WITH SELECTIVE CAPTURE; U.S. patent application Ser. No. 14/935,878, filed Nov. 9, 2015, entitled INSPECTION CAMERA DEVICES AND METHODS WITH SELECTIVELY ILLUMINATED MULTISENSOR IMAGING; U.S. patent application Ser. No. 14/970,362, filed Dec. 15, 2014, entitled COAXIAL VIDEO PUSH-CABLES FOR USE IN INSPECTION SYSTEMS; U.S. Pat. No. 9,222,809, issued Dec. 29, 2015, entitled PORTABLE PIPE INSPECTION SYSTEMS AND APPARATUS; United States Patent Application Ser. No. 15/050,267, filed Feb. 22, 2016, entitled SELF-LEVELING CAMERA HEADS; U.S. Pat. No. 9,277,105, issued Mar. 1, 2016, entitled SELF-LEVELING CAMERA HEADS; U.S. patent application Ser. No. 15/264,355, filed Sep. 13, 2016, entitled HIGH BANDWIDTH VIDEO PUSH-CABLES FOR PIPE INSPECTION SYSTEMS; U.S. Pat. No. 9,448,376, issued Sep. 20 2016, entitled HIGH BANDWIDTH PUSH-CABLES FOR VIDEO PIPE INSPECTION SYSTEMS; U.S. Pat. No. 9,468,954, issued Oct. 18, 2016, entitled PIPE INSPECTION SYSTEM WITH JETTER PUSH-CABLE; U.S. Pat. No. 9,477,147, issued Oct. 25, 2016, entitled SPRING ASSEMBLIES WITH VARIABLE FLEXIBILITY FOR USE WITH PUSH-CABLES AND PIPE INSPECTION SYSTEMS; U.S. patent application Ser. No. 15/369,693, filed Dec. 5, 2016, entitled CABLE STORAGE DRUM WITH MOVEABLE CCU DOCKING APPARATUS; U.S. Pat. No. 9,521,303, issued Dec. 13, 2016, entitled CABLE STORAGE DRUM MOVABLE CCU DOCKING APPARATUS; U.S. patent application Ser. No. 15/425,785, filed Feb. 6, 2017, entitled METHOD AND APPARATUS FOR HIGH-SPEED DATA TRANSFER EMPLOYING SELF-SYNCHRONIZING QUADRATURE AMPLITUDE MODULATION; U.S. Pat. No. 9,571,326, issued Feb. 14, 2017, entitled METHOD AND APPARATUS FOR HIGH-SPEED DATA TRANSFER EMPLOYING SELF-SYNCHRONIZING QUADRATURE AMPLITUDE MODULATION; U.S. patent application Ser. No. 15/483,924, filed Apr. 10, 2017, entitled SYSTEMS AND METHODS FOR DATA TRANSFER USING SELF-SYNCHRONIZING QUADRATURE AMPLITUDE MODULATION; U.S. Pat. No. 9,625,602, issued Apr. 18, 2017, entitled SMART PERSONAL COMMUNICATION DEVICES AS USER INTERFACES; U.S. Pat. No. 9,634,878, issued Apr. 25, 2017, entitled SYSTEMS AND METHODS FOR DATA TRANSFER USING SELF-SYNCHRONIZING QUADRATURE AMPLITUDE MODULATION; U.S. patent application Ser. No. 15/590,964, filed May 9, 2017, entitled BORING INSPECTION SYSTEMS AND METHODS; U.S. Pat. No. 9,651,711, issued May 16, 2017, entitled HORIZONTAL BORING INSPECTION DEVICE AND METHODS; U.S. patent application Ser. No. 15/670,845, filed Aug. 7, 2017, entitled HIGH FREQUENCY AC-POWERED DRAIN CLEANING AND INSPECTION APPARATUS AND METHODS; U.S. patent application Ser. No. 15/701,247, filed Sep. 11, 2017, entitled PIPE INSPECTION SYSTEMS WITH SELF-GROUNDING PORTABLE CAMERA CONTROLLERS; U.S. Pat. No. 9,769,366, issued Sep. 19, 2017, entitled ELF-GROUNDING TRANSMITTING PORTABLE CAMERA CONTROLLER FOR USE WITH PIPE INSPECTION SYSTEMS; U.S. Pat. No. 9,791,382, issued Oct. 17, 2017, entitled PIPE INSPECTION SYSTEM WITH JETTER PUSH-CABLE; U.S. patent application Ser. No. 15/728,410, filed Oct. 9, 2017, entitled PIPE INSPECTION SYSTEM WITH JETTER PUSH-CABLE; U.S. patent application Ser. No. 15/805,007, filed Nov. 6, 2017, entitled PIPE INSPECTION SYSTEM CAMERA HEADS; U.S. patent application Ser. No. 15/806,219, filed Nov. 7, 2017, entitled MULTI-CAMERA PIPE INSPECTION APPARATUS, SYSTEMS AND METHODS; U.S. patent application Ser. No. 15/811,264, filed Nov. 13, 2017, entitled SPRING ASSEMBLIES WITH VARIABLE FLEXIBILITY FOR USE WITH PUSH-CABLES AND PIPE INSPECTION SYSTEMS; U.S. Pat. No. 9,824,433, issued Nov. 21, 2017, entitled PIPE INSPECTION SYSTEM CAMERA HEADS; U.S. Pat. No. 9,829,783, issued Nov. 28, 2017, entitled SPRING ASSEMBLIES WITH VARIABLE FLEXIBILITY FOR USE WITH PUSH-CABLES AND PIPE INSPECTION SYSTEMS; U.S. Pat. No. 9,835,564, issued Dec. 5, 2017, entitled MULTI-CAMERA PIPE INSPECTION APPARATUS, SYSTEMS, AND METHODS; U.S. patent application Ser. No. 15/919,077, filed Mar. 27, 2018, entitled PORTABLE PIPE INSPECTION SYSTEMS AND METHODS; U.S. Pat. No. 9,914,157, issued Mar. 13, 2018, entitled METHODS AND APPARATUS FOR CLEARING OBSTRUCTIONS WITH A JETTER PUSH-CABLE APPARATUS; U.S. patent application Ser. No. 15/922,703, filed Mar. 15, 2018, entitled SELF-LEVELING INSPECTION SYSTEMS AND METHODS; U.S. Pat. No. 9,924,139, issued Mar. 20, 2018, entitled PORTABLE PIPE INSPECTION SYSTEMS AND APPARATUS; U.S. Pat. No. 9,927,368, issued Mar. 27, 2018, entitled SELF-LEVELING INSPECTION SYSTEMS AND METHODS; U.S. Provisional Patent Application 62/686,589, filed Jun. 18, 2018, entitled MULTI-DIELECTRIC COAXIAL PUSH-CABLES; U.S. Provisional Patent Application 62/726,500, filed Sep. 4, 2018, entitled VIDEO PIPE INSPECTION SYSTEMS, DEVICES, AND METHODS INTEGRATED WITH NON-VIDEO DATA RECORDING AND COMMUNICATION FUNCTIONALITY; U.S. Provisional Patent Application 62/756,538, filed Nov. 6, 2018, entitled ROBUST AND LOW COST IMPEDANCE CONTROLLED SLIP RINGS; U.S. Provisional Patent Application 62/768,760, filed Nov. 16, 2018, entitled PIPE INSPECTION AND/OR MAPPING CAMERA HEADS, SYSTEMS, AND METHODS; U.S. Provisional Patent Application 62/794,863, filed Jan. 21, 2019, entitled HEAT EXTRACTION ARCHITECTURE FOR COMPACT VIDEO HEADS; U.S. Patent Application Ser. No. 16/443,789, filed Jun. 17, 2019, entitled MULTI-DIELECTRIC COAXIAL PUSH-CABLES AND ASSOCIATED APPARATUS; U.S. Pat. No. 10,356,360, issued Jul. 16, 2019, entitled HIGH BANDWIDTH VIDEO PUSH-CABLE FOR PIPE INSPECTION SYSTEMS; U.S. Pat. No. 10,359,368, issued Jul. 23, 2019, entitled PIPE INSPECTION SYSTEM WITH JETTER PUSH-CABLE; U.S. Pat. No. 10,379,436, issued Aug. 13, 2019, entitled SPRING ASSEMBLIES WITH VARIABLE FLEXIBILIY FOR USE WITH PUSH-CABLES AND PIPEINSPECTION SYSTEMS; U.S. Pat. No. 10,440,332, issued Oct. 8, 2019, entitled INSPECTION CAMERA DEVICES AND METHODS WITH SELECTIVELY ILLUMINATED MULTISENSOR IMAGINING; U.S. Pat. No. 10,527,402, issued Jan. 7, 2020, entitled PIPE INSPECTION SYSTEM CABLE COUNTER AND OVERLAY MANAGEMENT SYSTEM; U.S. Pat. No. 10,585,012, issued Mar. 10, 2020, entitled PORTABLE CAMERA CONTROLLER FOR USE WITH PIPE INSPECTION SYSTEMS; U.S. Pat. No. 10,613,034, issued Apr. 7, 2020, entitled SELF-LEVELING INSPECTION SYSTEMS AND METHODS; U.S. Pat. No. 10,715,703, issued Jul. 14, 2020, entitled SELF-LEVELING CAMERA HEADS; U.S. Pat. No. 10,761,233, issued Sep. 1, 2020, entitled SONDES AND METHODS FOR USE WITH BURIED LINE LOCATOR SYSTEMS; U.S. Pat. No. 10,764,541, issued Sep. 1, 2020, entitled COAXIAL VIDEO PUSH-CABLES FOR USE IN INSPECTION SYSTEMS; U.S. patent application Ser. No. 17/087,554, filed Nov. 2, 2020, entitled PORTABLE PIPE INSPECTION SYSTEMS AND METHODS; U.S. Pat. No. 10,834,364, issued Nov. 10, 2020, entitled PORTABLE PIPE INSPECTION SYSTEMS AND METHODS; U.S. Pat. No. 10,841,144, issued Nov. 17, 2020, entitled SYSTEM AND METHODS FOR DATA TRANSFER USING SELF-SYNCHRONIZING QUADRATURE AMPLITUFE MODULATION (QAM); U.S. Pat. No. 10,855,950, issued Dec. 1, 2020, entitled HIGH BANDWIDTH VIDEO PUSH-CABLES FOR PIPE INSPECTION SYSTEMS; U.S. Pat. No. 10,863,064, issued Dec. 8, 2020, entitled CABLE STORAGE DRUM WITH MOVEABLE CCU DOCKING APPARATUS; U.S. Pat. No. 10,907,690, issued Feb. 2, 2021, entitled PIPE INSPECTION SYSTEMS WITH ASSYMETRIC DRAG FORCE BEARINGS; U.S. Pat. No. 10,921,263, issued Feb. 16, 2021, entitled PIPE INSPECTION SYSTEM WITH JETTER PUSH-CABLE; U.S. patent application Ser. No. 17/182,113, filed Feb. 22, 2021, entitled VIDEO PIPE INSPECTION SYSTEMS; U.S. patent application Ser. No. 17/202,128, filed Mar. 15, 2021, entitled BORING INSPECTION SYSTEMS AND METHODS; U.S. Pat. No. 10,955,583, issued Mar. 23, 2021, entitled BORING INSPECTION SYSTEMS AND METHODS; U.S. Pat. No. 10,976,462, issued Apr. 13, 2021, entitled VIDEO INSPECTION SYSTEMS WITH PERSONAL COMMUNICATION DEVICE USER INTERFACES; U.S. Pat. No. 10,992,849, issued Apr. 27, 2021, entitled PIPE INSPECTION SYSTEMS WITH SELF-GROUNDING PORTABLE CAMERA CONTROLLERS; U.S. Pat. No. 11,016,381, issued May 25, 2021, entitled SPRING ASSEMBLIES WITH VARIABLE FLEXIBLE FOR USE WITH PUSH-CABLES AND PIPE INSPECTION SYSTEMS; U.S. patent application Ser. No. 17/397,940, filed Aug. 9, 2021, entitled INSPECTION SYSTEM PUSH-CABLE GUIDE APPARATUS; U.S. Pat. No. 11,088,890, issued Aug. 10, 2021, entitled VIDEO INSPECTION SYSTEMS AND METHODS USING SELF-SYNCHRONIZING QAM; U.S. Pat. No. 11,132,781, issued Sep. 28, 2021, entitled PIPE INSPECTION SYSTEM CAMERA HEADS; U.S. patent application Ser. No. 17/528,155, filed Nov. 16, 2021, entitled PORTABLE CAMERA CONTROLLER PLATFORM FPR USE WITH PIPE INSPECTION SYSTEMS; U.S. Pat. No. 11,178,317, issued Nov. 16, 2021, entitled HEAT EXTRACTION APPARATUS; U.S. patent application Ser. No. 17/528,956, filed Nov. 17, 2021, entitled VIDEO INSPECTION SYSTEM APPARATUS AND METHODS WITH RELAY MODULES AND CONNECTION PORTS; U.S. patent application Ser. No. 17/531,533, filed Nov. 19, 2021, entitled INPUT MULTIPLEXED SIGNAL PROCESSING APPARATUS AND METHODS; U.S. patent application Ser. No. 17/532,938, filed Nov. 22, 2021, entitled PIPE INSPECTION AND/OR MAPPING CAMERA HEADS, SYSTEMS, AND METHODS; U.S. Pat. No. 11,187,822, issued Nov. 30, 2021, entitled SONDE DEVICES INCLUDING SECTIONAL FERRITE CORE STRUCTURE; U.S. Pat. No. 11,187,971, issued Nov. 30, 2021, entitled ROTATING CONTACT ASSEMBLIES FOR SELF-LEVELING CAMERA HEADS; U.S. Pat. No. 11,199,510, issued Dec. 14, 2021, entitled PIPE INSPECTION AND CLEANING APPARATUS AND SYSTEMS; U.S. Pat. No. 11,209,115, issued Dec. 28, 2021, entitled PIPE INSPECTION AND/OR MAPPING CAMERA HEADS, SYSTEMS, AND METHODS; U.S. Pat. No. 11,209,334, issued Dec. 28, 2021, entitled PORTABLE CAMERA CONTROLLER PLATFORM FOR USE WITH PIPE INSPECTION SYSTEMS; U.S. Pat. No. 11,300,700, issued Apr. 12, 2022, entitled SYSTEM AND METHODS OF USING A SONDE DEVICE WITH A SECTIONAL FERRITE CORE STRUCTURE; U.S. patent application Ser. No. 17/868,709, filed Jul. 19, 2022, entitled INSPECTION CAMERA DEVICES AND METHODS; U.S. patent application Ser. No. 17/815,387, filed Jul. 27, 2022, entitled INWARD SLOPED DRUM FACE FOR PIPE INSPECTION CAMERA SYSTEM; U.S. Pat. No. 11,402,337, issued Aug. 2, 2022, entitled VIDEO PIPE INSPECTION SYSTEMS WITH VIDEO INTEGRATED WITH ADDITIONAL SENSOR DATA; U.S. Pat. No. 11,418,761, issued Aug. 16, 2022, entitled INSPECTION CAMERA DEVICES AND METHODS WITH SELECTIVELY ILLUMINATED MULTISENSOR IMAGING; U.S. Pat. No. 11,448,600, issued Sep. 20, 2022, entitled MULTI-CAMERA PIPE INSPECTION APPARATUS, SYSTEMS, AND METHODS; U.S. patent application Ser. No. 17/993,784, filed Nov. 23, 2022, entitled VIDEO PIPE INSPECTION SYSTEMS; U.S. Pat. No. 11,528,401, issued Dec. 13, 2022, entitled PIPE INSPECTION SYSTEMS WITH SELF-GROUNDING PORTABLE CAMERA CONTROLLERS; U.S. patent application Ser. No. 18/091,079, filed Dec. 29, 2022, entitled VIDEO INSPECTION SYSTEMS WITH WIRELESS ENABLED DRUM; U.S. patent application Ser. No. 18/148,850, filed Dec. 30, 2022, entitled SPRING ASSEMBLIES WITH VARIABLE FLEXIBILITY FOR USE WITH PUSH-CABLES AND PIPEINSPECTION SYSTEMS; U.S. Pat. No. 11,550,214, issued Jan. 10, 2023, entitled SPRING ASSEMBLIES WITH VARIABLE FLEXIBLE FOR USE WITH PUSH-CABLES AND PIPE INSPECTION SYSTEMS; U.S. Pat. No. 11,558,537, issued Jan. 17, 2023, entitled VIDEO INSPECTION SYSTEM WITH WIRELESS ENABLED CABLE STORAGE DRUM; U.S. patent application Ser. No. 18/121,547, filed Mar. 14, 2023, entitled DOCKABLE CAMERA REEL AND CAMERA CONTROL UNIT (CCU) SYSTEM; U.S. patent application Ser. No. 18/121,562, filed Mar. 14, 2023, entitled PIPE INSPECTION AND CLEANING APPARATUS AND SYSTEMS; U.S. Provisional Patent Application 63/492,473, filed Mar. 27, 2023, entitled VIDEO INSPECTION AND CAMERA HEAD TRACKING SYSTEMS AND METHODS; U.S. Pat. No. 11,614,412, issued Mar. 28, 2023, entitled PIPE INSPECTION SYSTEMS WITH JETTER PUSH-CABLE; U.S. Pat. No. 11,614,613, issued Mar. 28, 2023, entitled DOCKABLE CAMERA REEL AND CCU SYSTEM; U.S. patent application Ser. No. 18/130,341, filed Apr. 3, 2023, entitled VIDEO PUSH-CABLES FOR PIPE INSPECTION SYSTEMS; U.S. Pat. No. 11,621,099, issued Apr. 4, 2023, entitled COAXIAL VIDEO PUSH-CABLES FOR USE IN INSPECTION SYSTEMS; U.S. patent application Ser. No. 18/135,661, filed Apr. 17, 2023, entitled VIDEO PIPE INSPECTION SYSTEMS AND METHODS WITH SENSOR DATA; U.S. patent application Ser. No. 18/140,488, filed Apr. 27, 2023, entitled INTEGRATED FLEX-SHAFT CAMERA SYSTEM; U.S. Pat. No. 11,639,990, issued May 2, 2023, entitled VIDEO PIPE INSPECTION SYSTEMS WITH VIDEO INTEGRATED WITH ADDITIONAL SENSOR DATA; U.S. Pat. No. 11,649,917, issued May 16, 2023, entitled INTEGRATED FLEX-SHAFT CAMERA SYSTEM WITH HAND CONTROL; U.S. Patent Application Ser. No. 18/203,029, filed May 29, 2023, entitled SELF-LEVELING INSPECTION SYSTEMS AND METHODS; U.S. Pat. No. 11,665,321, issued May 30, 2023, entitled PIPE INSPECTION SYSTEM WITH REPLACEABLE CABLE STORAGE DRUM; U.S. patent application Ser. No. 18/207,898, filed Jun. 9, 2023, entitled SONDE DEVICES WITH A SECTIONAL CORE; U.S. Pat. No. 11,674,906, issued Jun. 13, 2023, entitled SELF-LEVELING INSPECTION SYSTEMS AND METHODS; U.S. Provisional Patent Application 63/510,014, filed Jun. 23, 2023, entitled INNER DRUM MODULE WITH PUSH-CABLE INTERFACE FOR PIPE INSPECTION; U.S. Pat. No. 11,709,289, issued Jul. 25, 2023, entitled SONDE DEVICES WITH A SECTIONAL FERRITE CORE; U.S. patent application Ser. No. 18/365,225, filed Aug. 3, 2023, entitled SYSTEMS AND METHODS FOR INSPECTION ANIMATION; U.S. Pat. No. 11,719,376, issued Aug. 8, 2023, entitled DOCKABLE TRIPODAL CAMERA CONTROL UNIT; U.S. patent application Ser. No. 18/490,763, filed Oct. 20, 2023, entitled LINKED CABLE-HANDLING AND CABLE-STORAGE DRUM DEVICES AND SYSTEMS FOR THE COORDINATED MOOVEMENT OF A PUSH-CABLE; U.S. Provisional Patent Application 63/599,890, filed Nov. 16, 2023, entitled VIDEO INSPECTION AND CAMERA HEAD TRACKING SYSTEMS AND METHODS; U.S. patent application Ser. No. 18/528,773, filed Dec. 4, 2023, entitled PIPE INSPECTION SYSTEM CAMERA HEAD; U.S. Pat. No. 11,842,474, issued Dec. 12, 2023, entitled PIPE INSPECTION SYSTEM CAMERA HEADS; U.S. patent application Ser. No. 18/539,265, filed Dec. 14, 2023, entitled INTEGRAL DUAL CLEANER DRUM SYSTEMS AND METHODS; U.S. patent application Ser. No. 18/539,268, filed Dec. 14, 2023, entitled HIGH FREQUENCY AC-POWERED DRAIN CLEANING AND INSPECTION APPARATUS AND METHODS; U.S. Pat. No. 11,846,095, issued Dec. 19, 2023, entitled HIGH FREQUENCY AC-POWERED DRAIN CLEANING AND INSPECTION APPARATUS & METHODS; U.S. Pat. No. 11,859,755, issued Jan. 2, 2024, entitled INTEGRAL DUAL CLEANER CAMERA DRUM SYSTEMS AND METHODS; U.S. patent application Ser. No. 18/412,452, filed Jan. 12, 2024, entitled MULTI-CAMERA APPARATUS FOR WIDE ANGLE PIPE INTERNAL INSPECTION; U.S. patent application Ser. No. 18/414,785, filed Jan. 17, 2024, entitled SONDE DEVICES; U.S. Pat. No. 11,879,852, issued Jan. 23, 2024, entitled MULTI-CAMERA APPARATUS FOR WIDE ANGLE PIPE INTERNAL INSPECTION; U.S. Pat. No. 11,880,005, issued Jan. 23, 2024, entitled SONDE DEVICES INCLUDING A SECTIONAL FERRITE CORE STRUCTURE; U.S. Provisional Patent Application 63/625,259, filed Jan. 25, 2024, entitled ACCESSIBLE DRUM-REEL FRAME FOR PIPE INSPECTION CAMERA SYSTEM; U.S. Provisional Patent Application 63/552,522, filed Feb. 12, 2024, entitled ACCESSIBLE DRUM-REEL FRAME FOR PIPE INSPECTION CAMERA SYSTEM; U.S. Pat. No. 11,909,150, issued Feb. 20, 2024, entitled ROBUST IMPEDANCE CONTROLLED SLIP RINGS; U.S. patent application Ser. No. 18/611,449, issued Mar. 20, 2024, entitled VIDEO INSPECTION AND CAMERA HEAD TRACKING SYSTEMS AND METHODS; U.S. Pat. No. 11,962,943, issued Apr. 16, 2024, entitled INSPECTION CAMERA DEVICES AND METHODS; United States Patent, issued May 21, 2024, entitled MULTI-DIELECTRIC COAXIAL PUSH-CABLES AND ASSOCIATED APPARATUS; U.S. patent application Ser. No. 18/747,912, filed Jun. 19, 2024, entitled INNER DRUM MODULE WITH PUSH-CABLE INTERFACE FOR PIPE INSPECTION; U.S. Provisional Patent Application 63/674,749, filed Jul. 23, 2024, entitled PIPE MAPPING FOR FEATURE AND ASSET RECOGNITION USING ARTIFICIAL INTELLIGENCE; U.S. patent application Ser. No. 18/796,170, filed Aug. 6, 2024, entitled INTEGRATED FLEX-SHAFT CAMERA SYSTEM; and U.S. Pat. No. 12,060,964, issued Aug. 13, 2024, entitled INTEGRATED FLEX-SHAFT CAMERA SYSTEM; U.S. Provisional Patent 63/692,642, issued Sep. 9, 2024, entitled ELECTRONIC MODULES AND ASSOCIATED SYSTEMS; U.S. Provisional Patent 63/694,102, issued Sep. 12, 2024, entitled METHODS AND APPARATUS FOR BATTERY SWAPPING IN UTILITY LOCATOR DEVICES AND OTHER COMPLEX BOOTABLE ELECTRONIC DEVICES; U.S. Provisional Patent 63/719,026, issued Nov. 11, 2024, entitled PUSH-CABLE WITH OFFSET JACKET EXTRUSION; U.S. Provisional Patent 63/726,858, issued Dec. 2, 2024, entitled DIGITAL SELF-LEVELING PIPE INSPECTION CAMERA SYSTEMS AND METHODS WITH AUTOMIC MAGNIFICATION; U.S. patent application Ser. No. 19/018,842, issued Jan. 13, 2025, entitled ACCESSIBLE DRUM-REEL FRAME FOR PIPE INSPECTION CAMERA SYSTEM; U.S. Provisional Patent Application 63/761,029, filed Feb. 20, 2025, entitled UTILITY LOCATING SYSTEMS, DEVICES, AND METHODS EMPLOYING SPATIAL AUDIO; U.S. patent application Ser. No. 19/059,288, filed Feb. 21, 2025, entitled SYSTEMS, DEVICES, AND METHODS FOR DOCUMENTING GROUND ASSETS AND ASSOCIATED UTILITY LINES; U.S. Provisional Patent Application 63/770,287, filed Mar. 11, 2025, entitled WORLD FRAME/LOCAL FRAME MAPPING AND RE-MAPPING IN A UTILITY LOCATION SYSTEM; U.S. Pat. No. 12,253,382, issued Mar. 18, 2025, entitled VEHICLE-BASED UTILITY LOCATING USING PRINCIPAL COMPONENTS; U.S. patent application Ser. No. 18/198,495, filed May 18, 2025, entitled SYSTEMS AND METHODS FOR LOCATING AND MAPPING BURIED UTILITY OBJECTS USING ARTIFICIAL INTELLIGENCE WITH LOCAL OR REMOTE PROCESSING; U.S. patent application Ser. No. 19/234,473, filed Jun. 11, 2025, entitled VEHICLE-MOUNTING DEVICES AND METHODS FOR USE IN VEHICLE-BASED LOCATING SYSTEMS; U.S. Pat. No. 12,360,251, issued Jul. 15, 2025, entitled GNSS POSITIONING METHODS AND DEVICES USING PPP-RTK, RTK, SSR, ORLIKE CORRECTION DATA; U.S. Pat. No. 12,360,282, issued Jul. 15, 2025, entitled NATURAL VOICE UTILITY ASSET ANNOTATION SYSTEM; U.S. Pat. No. 12,363,251, issued Jul. 15, 2025, entitled SYSTEMS ANDMETHODS FOR INSPECTION ANIMATION; U.S. patent application Ser. No. 19/274,389, filed Jul. 18, 2025, PIPE MAPPING FOR FEATURE AND ASSET RECOGNITION USING ARTIFICIAL INTELLIGENCE; U.S. Pat. No. 12,368,944, issued Jul. 22, 2025, entitled INNER DRUM MODULE WITH PUSH-CABLE INTERFACE FOR PIPE INSPECTION; U.S. Pat. No. 12,374,875, issued Jul. 29, 2025, entitled INSPECTION SYSTEM PUSH-CABLE GUIDE APPARATUS; U.S. Pat. No. 12,374,876, issued Jul. 29, 2025, entitled VEHICLE INSPECTION SYSTEM APPARATUS AND METHODS WITH RELAY MODULES AND CONNECTION PORTS; U.S. patent application Ser. No. 19/324,044, filed Sep. 9, 2025, entitled ELECTRONIC MODULES AND ASSOCIATED SYSTEMS; and U.S. patent application Ser. No. 19/324,880, filed Sep. 10, 2025, entitled METHODS ANDAPPARATUS FOR BATTERY SWAPPING IN UTILITY LOCATOR DEVICES ANDOTHER COMPLEXBOTTABLE ELECTRONIC DEVICES. The content of each of the above-described patents and applications is incorporated by reference herein in its entirety. The above-described patent applications and patents may be referred to herein collectively as the “incorporated applications.”

### BRIEF DESCRIPTION OF THE DRAWINGS

FIG. 1 illustrates details of an embodiment of a pipe inspection system configured with a multi-dielectric coaxial push-cable, as known in the prior art.

FIG. 2 is an illustration of an embodiment of coaxial video push-cable, as known in the prior art.

FIG. 3A is an illustration of an embodiment of a video push-cable with an offset jacket extrusion, in accordance with certain aspects of the present invention.

FIG. 3B is an illustration of an embodiment of the two parallel bonded flexible conductors 320 from FIG. 3A, in accordance with certain aspects of the present invention.

FIG. 4A-4C are illustrations of alternate embodiments of a video push-cable, in accordance with certain aspects of the present invention.

FIG. 5 is an illustration of an embodiment of a video push-cable with improved resiliency, in accordance with certain aspects of the present invention.

FIGS. 6A and 6B are illustrations alternate embodiments of a video push-cable with a fused main jacket, in accordance with certain aspects of the present invention.

FIGS. 7A, 7B, 7C, and 7D are illustrations of alternate embodiments of a video push-cable with an insulated electrical cable, in accordance with certain aspects of the present invention.

### DETAILED DESCRIPTION

It is noted that as used herein, the term “exemplary” means “serving as an example, instance, or illustration.” Any aspect, detail, function, implementation, and/or embodiment described herein as “exemplary” is not necessarily to be construed as preferred or advantageous over other aspects and/or embodiments.

### Example Embodiments

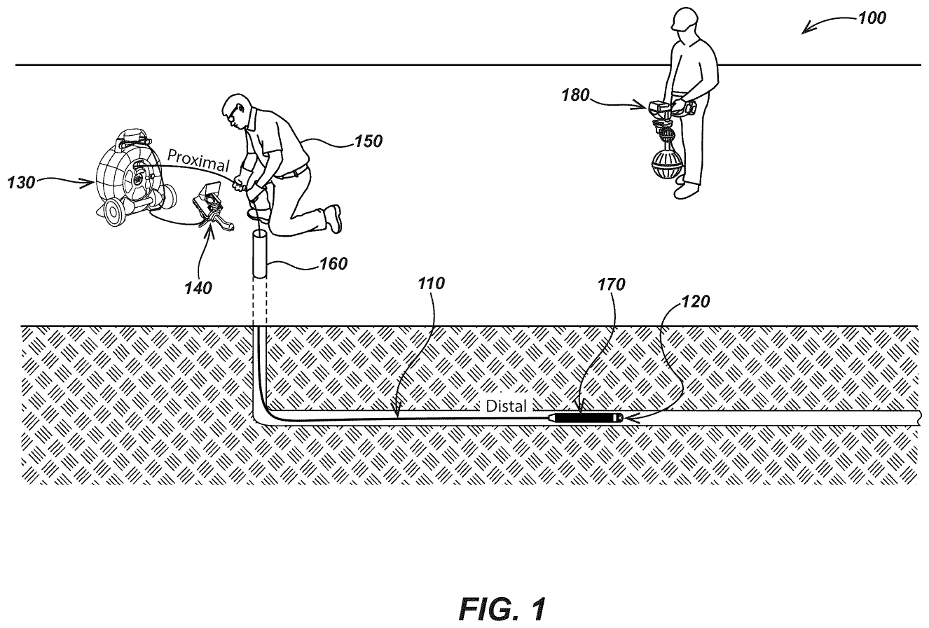

FIG. 1 illustrates details of an exemplary pipe inspection system 100 which includes a multi-dielectric coaxial push-cable 110. System 100 further includes a camera head 120 coupled to the distal end of the multi-dielectric coaxial push-cable 110 and a push-cable storage drum-reel 130 and a camera control unit (CCU) 140 along the proximal end of push-cable 110. A video inspection operation such as that which may be performed with the system 100 may begin with the push-cable 110 being dispensed into a pipe 160 (or conduit or other cavity, not shown) by drawing the push-cable 110 from the drum-reel 130, as well as storing the video push-cable 110 upon retraction from the pipe 160 by feeding it back onto the drum-reel 130, either mechanically or manually, by an operator 150. The push-cable 110 provides a mechanical connection between the drum-reel 130 at the proximal end of the push-cable 110 and camera head 120 at a distal end, as well as an electrical connection for power and signaling between the camera head 120 and CCU 140 (or other coupled device). An optional coil spring 170 may be positioned around a segment of push-cable 110 at or near the distal end and behind camera head 120 for additional protection and maneuverability to the camera head 120. A utility locator 180 may be used in conjunction with a video pipe inspection system to determine a location, relative to the ground surface, of the camera head 120 based on magnetic field signals generated from the camera head, or other magnetic field sources, such as from current flowing in wires in the push-cable or buried pipe or other conductors.

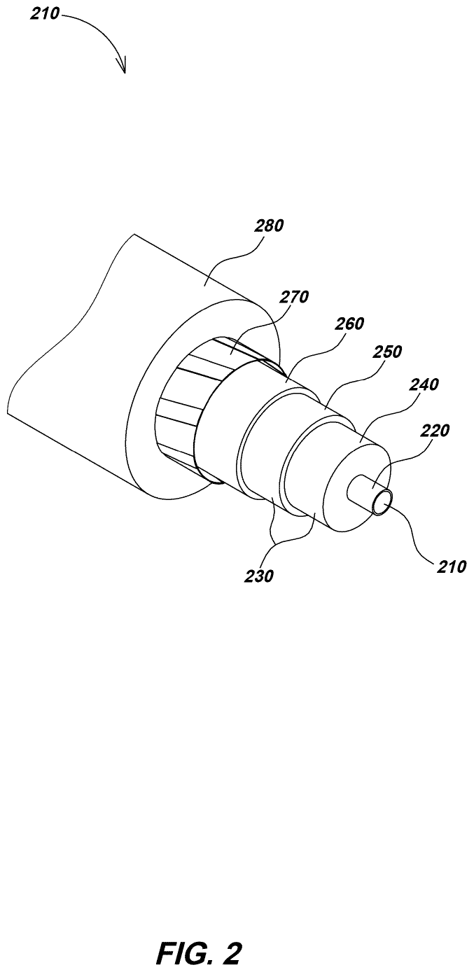

FIG. 2 illustrates details of an exemplary embodiment of coaxial video push-cable 200, as known in the prior art. Push-cable 200 includes a central conductor 210, which is typically copper or copper alloy, silver or silver alloy, copper-clad steel, or other highly conductive material or alloy for transmitting electrical power, as well as communicating data or image signals. The central conductor 210 may optionally be wrapped in an insulating wrap layer 220 which may be a polytetrafluoroethylene film or other similar insulating material. A multi-dielectric stack 230 of multiple concentric tubular layers are disposed around the central conductor 210 and optional insulating wrap layer 220 comprising one or more structural layers, such as the structural layer 240, and one or more impedance tuning layers 250. The multi-dielectric coaxial push-cable 200 may further include an electromagnetic shielding layer 260 which may be of an electromagnetically conductive material or alloy. The multi-dielectric coaxial push-cable 200 may include a friction modifier layer 270 disposed between the shielding layer 260 and jacket 280.

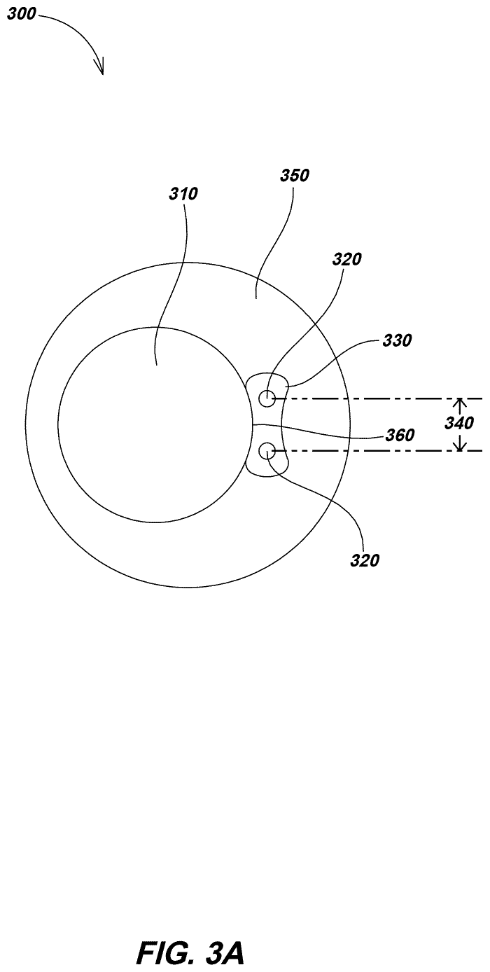

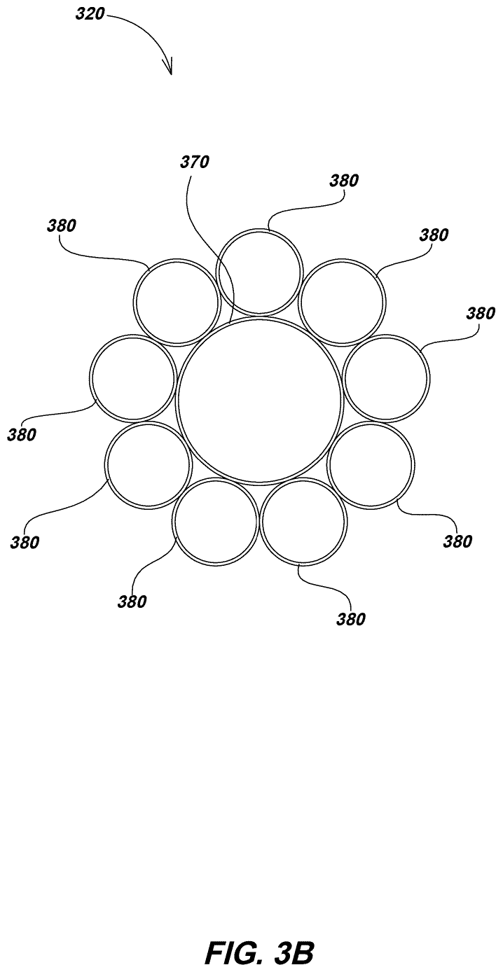

FIG. 3A illustrates details of of a video push-cable with an offset jacket extrusion 300. A central structural element 310 provides flexible resiliency to the cable so that it may be pushed and/or pulled, and otherwise navigated through underground and/or hidden pipes or conduits. Two parallel bonded flexible conductors 320 surrounded by insulation 330 are positioned adjacent to central structural element 310. A jacket 350 provides environmental and electrical protection to video push-cable 300. Insulation 330 may be shaped similar to an hourglass or a dog bone, i.e. with substantially symmetrical, and tapered sides, so that one side on the insulation 330 makes contact with the central structural element 310 at a contact point 360 between them. An offset between conductors 340 is the distance measured between the two conductors 320 from each other.

FIG. 3B illustrates details of the two parallel bonded flexible conductors 320 from FIG. 3A. Each of the two conductors 320 may include a nylon rod 370 surrounded by a plurality of flexible copper conductive rods or stranded copper wire 380. The number of conductive rods 380, as well as the proportions, and exact configuration shown, are only an example. Other specific configurations may be used, and can be determined based on design requirements, such as the desired size of video push-cable 300 (see FIG. 3A), the amount and type of insulation 330 used, and other engineering requirements.

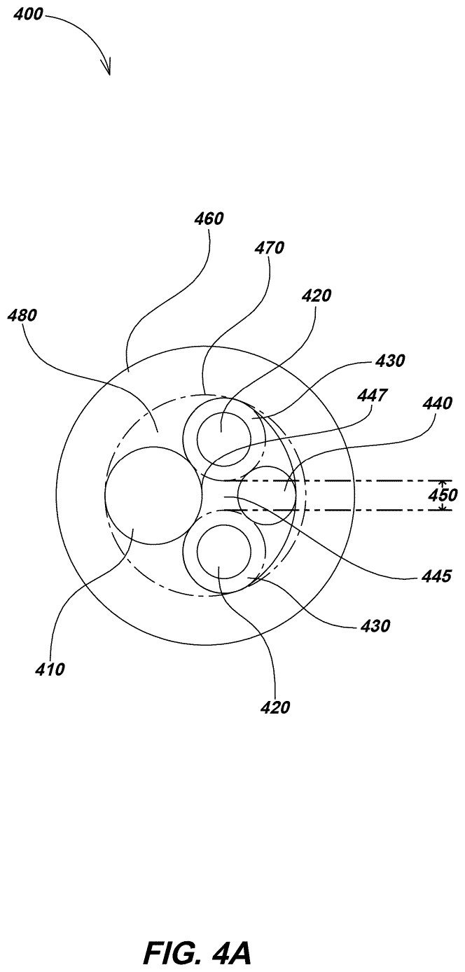

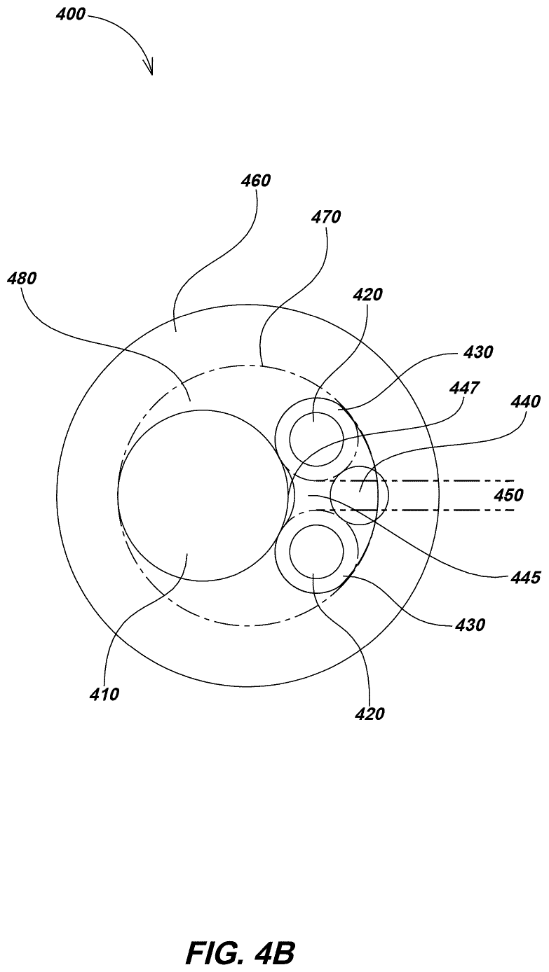

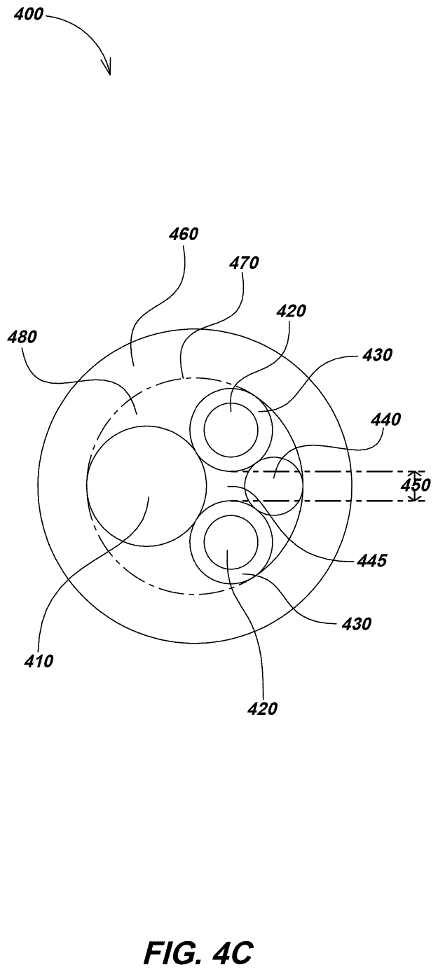

FIG. 4A-4C illustrate details of of a video push-cable with an offset jacket extrusion 400, in an alternate embodiments. A central structural element 410 provides flexible resiliency to the cable so that it may be pushed and/or pulled, and otherwise navigated through underground and/or hidden pipes or conduits. Central structural element 410 may be a fiberglass rod. Two electrical conductors 420 surrounded by conductor insulation 430 are positioned adjacent to central structural element 410. The two conductors 420 may be individual conductors or parallel bonded conductors. The two conductors 420 may include solid copper rods or stranded copper wire. A safety cable 440 adds additional strength and flexibility to the video push-cable 400. Safety cable 440 may comprise a stranded cable, for example Aircraft cable.

Parallel bonding insulation 445 provides an offset 450 between conductors 420. The offset 550 is the distance measured between the conductor insulation 430 surrounding the two conductors 420. A cable outer jacket 460 provides environmental and electrical protection to video push-cable 400. Insulation 445 may be shaped so that one side makes contact with the central structural element 410 at a contact point 447 between them. The cable outer jacket interior wall 470 may separated from the cable components by additional interstitial plastic 480 which may be formed when extruded during the manufacturing process. In traditional push-cable manufacturing, additional interstitial plastic is not typically formed. Although the additional interstitial plastic 480 creates a small amount of undesirable biased bending (the cable tends to want to bend in a certain direction because the distribution of material in regard to the bending axis changes), it is an acceptable tradeoff in these embodiments (FIGS. 4A-C) because these push-cable configurations improve maintainability of the cable. For instance, if push-cable 400 breaks, the bad portion can be removed, and then the conductor insulation 430 can be easily cut away or otherwise removed to allow access, and therefore, easy termination of the electrical conductors 420.

In FIGS. 4A to 4C, conductors 420 and conductor insulation 430 together, can be considered an electrical transmission line. For specific sizes (diameters) of electrical transmission lines a manufacturer has on hand, different size push-cables 400 can be made simply by changing the sizes (diameter) of the central structural element 410.

As an example, in FIG. 4A, the diameter of central structural element 410 is about the same diameter as the diameter of the transmission lines (conductor 420 with conductor insulation 430). In FIG. 4B, the diameter of central structural element 410 is bigger than the diameter of the transmission lines (conductors 420 with conductor insulation 430). In FIG. 4C, the diameter of central structural element 410 is smaller than the diameter of the transmission lines (conductors 420 with conductor insulation 430). As the size of the central structural element 410 changes, so too will the overall diameter of push-cable 400 change, for the same given size (diameter) of transmission lines (conductors 420 with conductor insulation 430).

In FIGS. 4A to 4C the size (diameter) of safety cable 440 is shown approximately constant, however, this diameter may be changed as well. Changing the size (diameter) of safety cable 440 will also result in a change in the overall size (diameter) of video push-cable 400.

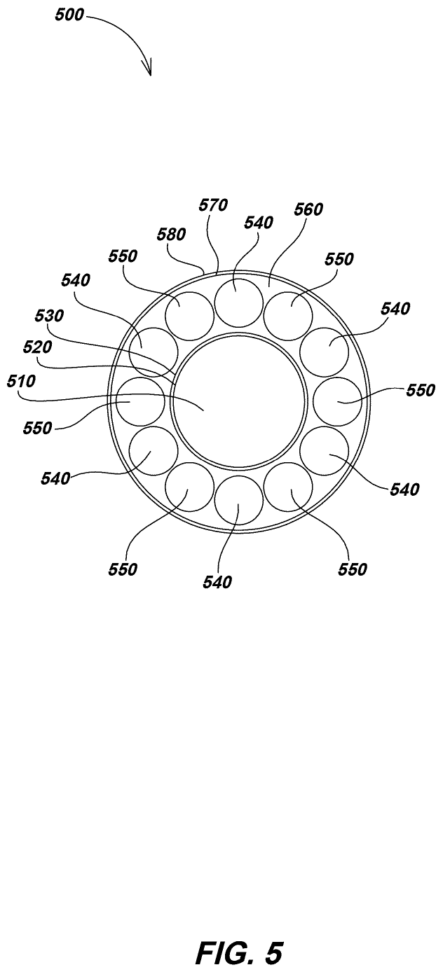

FIG. 5 illustrates details of an exemplary embodiment 500 or a video push-cable with improved resiliency. A flexible resilient central structural element 510 is provided. In some embodiments, central structural element 510 may include a fiberglass rod. Multiple concentric layers surrounding the central element 510 are provided, and may include an inner conductive layer 520, an insulation layer 530, a plurality of elastic rods 540, and a plurality of dielectric rods 550. Elastic rods 540 may include fiberglass rods. In some embodiments, the plurality of elastic rods 540, and the plurality of dielectric rods 550, may surround the central structural element 510 in an alternating pattern as shown. An outer conductive layer 570 surrounds the elastic rods 540 and dielectric rods 550. The interstitial space or void 560 between and surrounding the elastic rods 540 and the dielectric rods 550 may comprise air, or be back-filled with a water-blocking compound. A jacket 580 enclosing the multiple concentric layers and the central structural element may included to provide electrical and/or environmental protection to video push-cable 500.

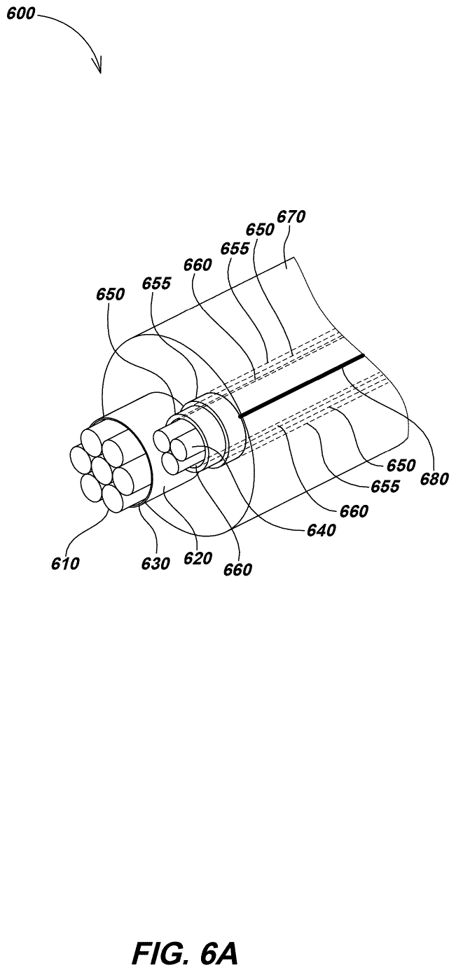

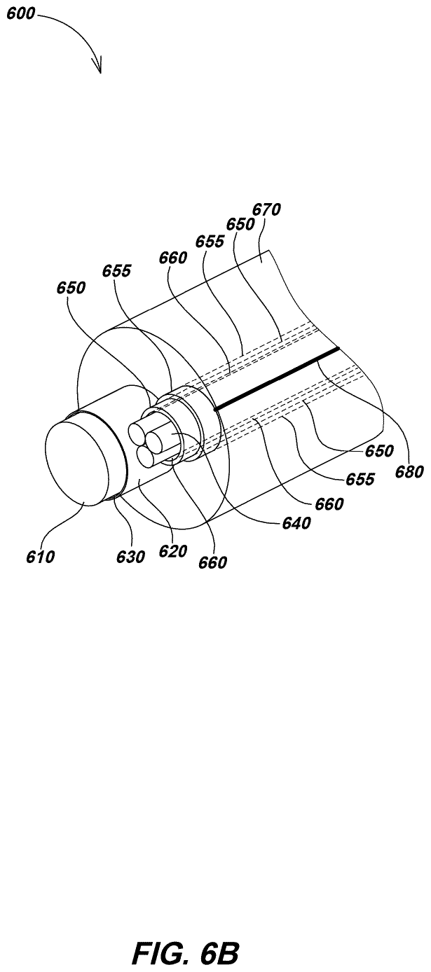

FIGS. 6A and 6B illustrate details of an exemplary embodiment 600 of video push-cable with a fused main jacket. One or more flexible resilient central structural elements 610 are provided. In one embodiment, central structural element 610 may be a single fiberglass rod (FIG. 6B). In another embodiment, central structural element 610 may comprise a bundle of fiberglass rods (FIG. 6A), which optionally may be wrapped in tape, e.g. mylar tape. As an example, the bundled fiberglass could be seven strand, slightly twisted. It would be obvious to one skilled in the art that many other configurations could be used, depending on the specific application. A jacket 620 may be provided for enclosing, and offering some protection to the structural elements 610. Any interstitial space or void 630 which may exist between multiple structural rods 610 (FIG. 6A), and/or the jacket 620 may comprise air, or be back-filled with a water-blocking compound.

An electrical core cable comprising one or more electrical conductors 640 is provided. The conductors 640 are surrounded by an inner conductor jacket 650, and an outer protective jacket 655. Any interstitial space or void 660 between the electrical conductors 640, and/or the inner protective jacket 650 may comprise air, or be back-filled with a water-blocking compound. The flexible resilient central structural elements 610 enclosed by jacket 630, and the electrical conductors 640 enclosed by protective jacket 650, are then all manufactured via an extrusion process such that all components are encapsulated by a non-conductive, flexible outer or main jacket 670. The outer or main jacket 670 may 670 may be made of UHMW (ultra high molecular weight polyethylene), polypropylene, Teflon®, or any other suitable material that provides electrical isolation, as well as environmental protection to the push-cable. The outer or main jacket 670 may be circular or slightly oval.

The jacketed electrical conductors form an electrical cable. An extrusion process may be used to manufacture video push-cable 600. In one embodiment, the outer or main jacket 670 may be fused to the electrical cable. In some embodiments, the color of the outer or main jacket 670, and the electrical cable may be different. This contrast in colors may result in a clear delineation or stripe 680 on the outer or main jacket 670.

In another embodiment, the inner electrical cable (electrical conductors 640 enclosed by jacket 650) would not be fused to the outer or main jacket 670.

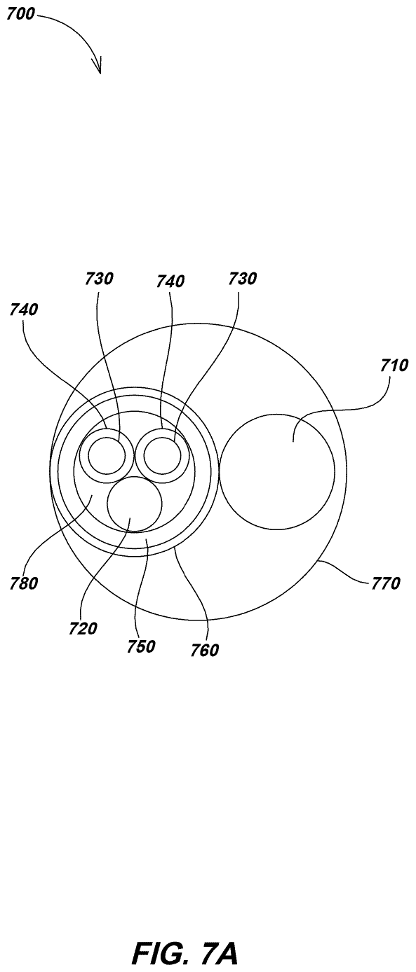

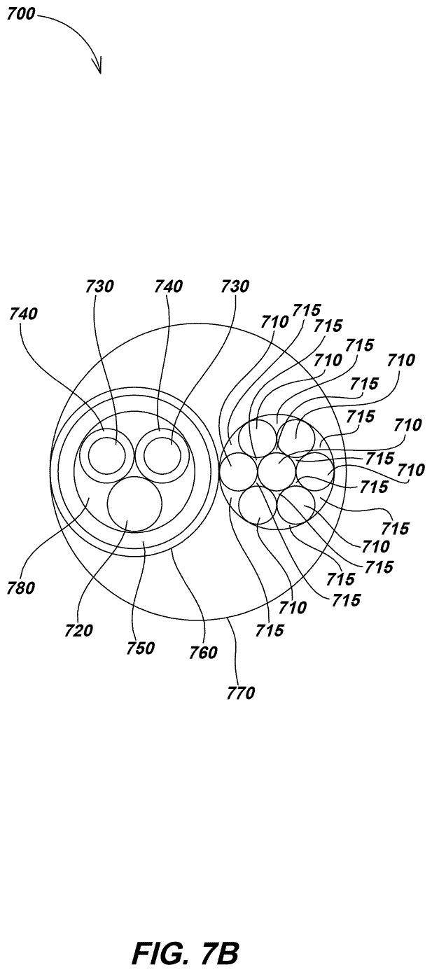

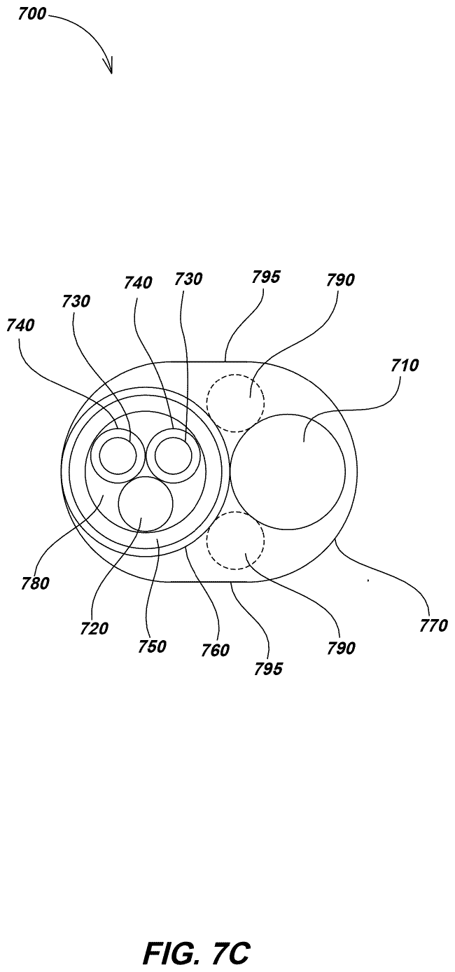

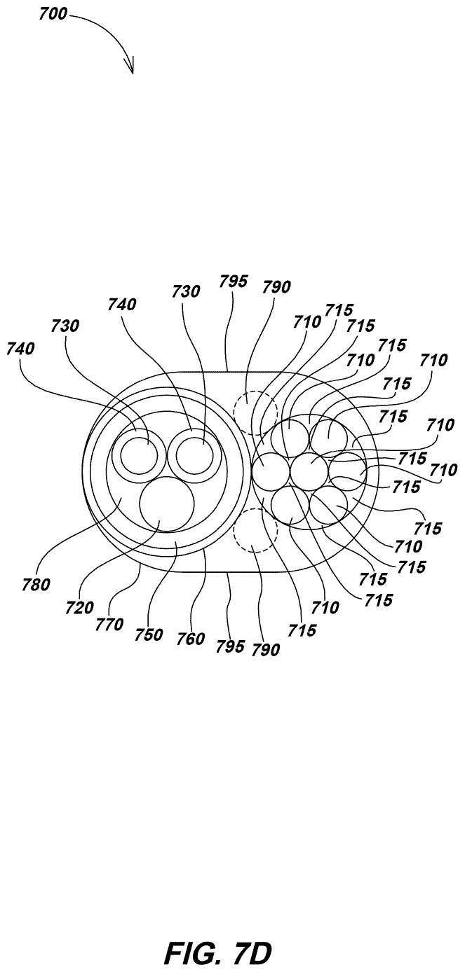

FIGS. 7A and 7B illustrate details of an exemplary embodiment 700 of a video push-cable with an insulated electrical cable forming part of the outside jacket of the video push-cable. One or more flexible resilient central structural elements 710 are provided. In one embodiment, central structural element 710 may be a single fiberglass rod (FIG. 7A). In another embodiment, central structural element 710 may comprise a bundle of fiberglass rods 710 (FIG. 7B). The interstitial space or void 715 between and surrounding the fiberglass rods 710, and outer or main jacket 770 may comprise air, or be back-filled with a water-blocking compound.

The one or more flexible resilient central structural elements 710 may optionally be wrapped in tape, e.g. mylar tape. As an example, the bundled fiberglass could be seven strand, slightly twisted. If a bundle of fiberglass rods is used, the It would be obvious to one skilled in the art that many other configurations could be used, depending on the specific application.

An electrical core cable comprising one or more electrical conductors 720 and 730 is provided. The electrical conductors may include a bare conductor 720, and one or more twisted triad conductors 730, which are insulated 740. The electrical conductors 720 and 730 may be surrounded by an inner conductor insulation or jacket 750, and an outer conductor insulation or jacket 760. The flexible resilient central structural elements 710, and the electrical conductors 720 and 730 are then all manufactured via an extrusion process such that all components are encapsulated by a non-conductive, flexible outer or main jacket 770. The interstitial space or void 780 between and surrounding electrical conductors 720 and 730, and inner conductor jacket 750 may comprise air, or be back-filled with a water-blocking compound.

FIGS. 7C and 7D illustrate details of an exemplary embodiment 700 of a video push-cable with an insulated electrical cable forming part of the outside jacket of the video push-cable. FIGS. 7C and 7D have the same components as FIGS. 7A and 7D, respectively (see previous description), except that outer or main jacket 770 has two opposing flat faces 790. Optionally, one or more fillers 795 may be provided to improve the strength, and help maintain the shape of video push-cable 700.

The scope of the invention is not intended to be limited to the aspects shown herein but are to be accorded the full scope consistent with the disclosures herein and their equivalents, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c.

The previous description of the disclosed aspects is provided to enable any person skilled in the art to make or use embodiments of the present invention. Various modifications to these aspects will be readily apparent to those skilled in the art, and the generic principles defined herein may be applied to other aspects without departing from the spirit or scope of the disclosure. Thus, the disclosure is not intended to be limited to the aspects shown herein but is to be accorded the widest scope consistent with the disclosures herein and in the appended drawings.

We claim:

1. A video push-cable, comprising:
a flexible resilient central structural element, comprising:
a fiberglass rod; and
an insulation jacket surrounding the central structural bundle;
an electrical cable, comprising:
a conductor bundle including a plurality of electrical conductors, wherein the plurality of electrical conductors include at least one insulated twisted triad conductor;
a first inner layer of conductor insulation, and a second outer layer of conductor insulation surrounding the conductor bundle; and
an outer insulation jacket surrounding the flexible resilient central structural bundle and the electrical cable, wherein the outer insulation jacket is fused to the electrical cable such that the electrical cable forms part of the outer insulation jacket.

2. The video push-cable of claim 1, wherein the plurality of electrical conductors includes at least one bare conductor larger than the at least one twisted triad conductor.

3. The video push-cable of claim 1, wherein the outer insulation jacket is round or substantially round shaped.

4. The video push-cable of claim 1, wherein the outer insulation jacket has two opposing flat or substantially flat sides, and two opposing curved sides.

5. The video push-cable of claim 4, further comprising at least one filler element positioned within the outer insulation jacket, and extending a full length of the push-cable.

6. A video push-cable, comprising:
a flexible resilient central structural element, comprising:
a plurality of fiberglass rods; and
an insulation jacket surrounding the central structural bundle;
an electrical cable, comprising:
a conductor bundle including a plurality of electrical conductors, wherein the plurality of electrical conductors include at least one triad conductor;
a first inner layer of conductor insulation, and a second outer layer of conductor insulation surrounding the conductor bundle; and
an outer insulation jacket surrounding the flexible resilient central structural bundle and the electrical cable, wherein the outer insulation jacket is fused to the electrical cable such that the electrical cable forms part of the outer insulation jacket.

7. The video push-cable of claim 6, wherein the plurality of electrical conductors includes at least one bare conductor larger than the at least one twisted triad conductor.

8. The video push-cable of claim 6, wherein the outer insulation jacket is round or substantially round shaped.

9. The video push-cable of claim 6, wherein the outer insulation jacket has two opposing flat or substantially flat sides, and two opposing curved sides.

10. The video push-cable of claim 9, further comprising at least one filler element positioned within the outer insulation jacket, and extending a full length of the push-cable.

11. A video push-cable, comprising:
a flexible resilient central structural element;
two parallel bonded flexible conductors positioned adjacent to, and in contact with the central structural element along a full length of the central structural element, wherein the two conductors are insulated from each other, and wherein the insulation provides substantially equidistancing between the two conductors along a full length of the central structural element; and
a jacket enclosing the central structural element and the two conductors.

12. The video push-cable of claim 11, wherein the central structural element comprises a circular rod.

13. The video push-cable of claim 12, wherein the central structural element comprises one or more of fiberglass, Kevlar®, and Spectra®.

14. The video push-cable of claim 13, wherein the jacket comprises UHMW (ultra high molecular weight polyethylene).

15. The video push-cable of claim 13, wherein the jacket comprises polypropylene.

16. The video push-cable of claim 13, wherein the jacket comprises Teflon®.

17. The video push-cable of claim 11, wherein the insulation completely surrounds the two conductors, and wherein the insulation is substantially hourglass shaped such that one of two concave shaped sides follows the curvature, and makes contact with the central structural element.

18. The video push-cable of claim 11, wherein one or more of an insulation shape surrounding the two conductors, a spacing between the two conductors, and an insulation material are selected to provide a pre-defined electrical impedance value.

19. The video push-cable of claim 11, wherein the two conductors each comprise a plurality of flexible copper conductive rods or stranded copper wires positioned substantially symmetrically around a nylon core.

20. The video push-cable of claim 11, wherein the central structural element and the two conductors are offset from the center of the jacket.

21. The video push-cable of claim 20, wherein the offset comprises an offset value that is selected to provide a pre-defined elastic modulus value.

22. The video push-cable of claim 11, wherein the jacket is shaped slightly oval.

23. The video push-cable of claim 11, wherein the two conductors each comprise a center nylon rod surrounded by a plurality of conductive elements.

24. The video push-cable of claim 11, wherein the conductive elements comprise spiraled copper tubular rods.

25. The push-cable of claim 11, wherein of an insulation shape surrounding the two conductors comprises polypropylene.

26. The push-cable of claim 25, wherein the polypropylene is oiled polypropylene.

27. The push-cable of claim 11, wherein the flexible resilient central structural element and the two parallel bonded flexible conductors are bonded together.

28. A video push-cable, comprising:
a flexible resilient central structural element;
multiple concentric layers surrounding the central structural element, comprising:
an inner conductive layer;
a plurality of elastic rods and a plurality of dielectric rods, wherein the elastic rods and the dielectric rods are alternated to surround the central core;
an outer conductive layer; and
a jacket enclosing the multiple concentric layers and the central structural element.

29. The video push-cable of claim 28, wherein the central structural element comprises a circular rod.

30. The video push-cable of claim 29, wherein the central structural element comprises fiberglass.

31. The video push-cable of claim 29, wherein the jacket comprises polypropylene.

32. The video push-cable of claim 29, wherein the jacket comprises Teflon®.

33. The video push-cable of claim 29, further comprising tape layer between the inner conductive layer and the plurality of elastic rods and dielectric rods.

34. The video push-cable of claim 29, wherein an open spacing between the plurality of elastic rods and the plurality of dielectric rods is filled with one or more of air or back-filled with a water-blocking compound.

35. The video push-cabled of claim 29, wherein the inner conductive layer comprises one or more of braided copper and a braided copper alloy.

36. The video push-cabled of claim 29, wherein the outer conductive layer comprises one or more of braided copper and a braided copper alloy.

37. The video push-cabled of claim 29, wherein the jacket is substantially round shaped.

38. The video push-cabled of claim 29, wherein the jacket is slightly oval shaped.

39. A video push-cable, comprising:
a flexible resilient central structural element;
two parallel bonded flexible conductors positioned adjacent to, and in contact with the a central structural element along a full length of the central structural element, wherein the two conductors are insulated from each other, and wherein the insulation provides substantially equidistancing between the two conductors along a full length of the central structural element;
a safety cable element positioned adjacent to, and in contact with the two parallel bonded flexible conductors, wherein the central structural element, and the safety cable element are on opposite sides of the two parallel flexible conductors; and
a jacket enclosing the central structural element, the safety cable element, and the two parallel bonded flexible conductors.

40. The video push-cable of claim 39, wherein the safety cable element comprises a stranded cable.

41. A video push-cable, comprising:
a flexible resilient central structural bundle, comprising:
a plurality fiberglass rods; and
an insulation jacket surrounding the central structural bundle;
an electrical cable, comprising:
a conductor bundle including a plurality of electrical conductors, wherein the electrical conductors include a first inner layer of conductor insulation, and a second outer layer of conductor insulation; and
an outer insulation jacket surrounding the flexible resilient central structural bundle and the electrical cable, wherein the outer insulation jacket is fused to the electrical cable such that the electrical cable forms part of the outer insulation jacket.

42. The video push-cable of claim 41, wherein the outer insulation jacket, and the electrical cable (insulation) are different colors.

43. The video push-cable of claim 42, wherein the electrical cable color is black, and the stripe color is green.

44. The video push-cable of claim 41, wherein the plurality of fiberglass rods are wrapped in mylar tape.

45. The video push-cable of claim 41, wherein the plurality of fiberglass rods comprise one or more of seven strand fiberglass rods and slightly twisted fiberglass rods.

46. The video push-cable of claim 41, wherein the outer insulation jacket comprises one or more of UHMW (ultra high molecular weight polyethylene), polypropylene, and Teflon®,
protection to the push-cable.

47. The video push-cable of claim 41, wherein the outer or main jacket is substantially circular or oval.

48. A video push-cable, comprising:
a flexible resilient central structural element, comprising:
a fiberglass rod; and
an insulation jacket surrounding the central structural bundle;
an electrical cable, comprising:
a conductor bundle including a plurality of electrical conductors; and
an outer insulation jacket surrounding the flexible resilient central structural bundle and the electrical cable, wherein the outer insulation jacket is fused to the electrical cable such that the electrical cable forms part of the outer insulation jacket.
